(19) United States
(12) Patent Application Publication
(10) Pub. No.: US 2025/0207959 A1
(43) Pub. Date: Jun. 26, 2025

(54) PRESSURE FLOW RATE SENSOR, FLOW RATE CALCULATION DEVICE, FLOW RATE CALCULATION METHOD, FLOW RATE CALCULATION PROGRAM, AND FLUID CONTROL DEVICE

(71) Applicant: HORIBA STEC, Co., Ltd., Kyoto-shi (JP)

(72) Inventor: Shuntaro YOKOI, Kyoto-shi (JP)

(21) Appl. No.: 18/990,774

(22) Filed: Dec. 20, 2024

(30) Foreign Application Priority Data
Dec. 22, 2023 (JP) 2023-216706

(51) Int. Cl. G01F 1/36

(52) U.S. Cl. CPC G01F 1/36

(57) ABSTRACT

The present invention is configured to calculate a flow rate across a wide range of flow rate, from a low range to a high range, and includes: a fluid resistance element provided to a channel; an upstream pressure sensor that detects an upstream pressure with respect to the fluid resistance element; a downstream pressure sensor that detects a downstream pressure with respect to the fluid resistance element; and a flow rate calculation unit that calculates a flow rate based on the upstream pressure and the downstream pressure, in which the flow rate calculation unit calculates the flow rate based on viscous resistance, inertial resistance, and a degree of effect of rarefaction.

### CROSS-REFERENCE TO RELATED APPLICATION

The present application claims priority to Japanese Patent Application No. 2023-216706 filed Dec. 22, 2023, entitled “PRESSURE FLOW RATE SENSOR, FLOW RATE CALCULATION DEVICE, FLOW RATE CALCULATION METHOD, FLOW RATE CALCULATION PROGRAM, AND FLUID CONTROL DEVICE,” which is incorporated herein by reference in its entirety.

### BACKGROUND OF THE INVENTION

### Technical Field

The present invention relates to a pressure flow rate sensor, a flow rate calculation device, a flow rate calculation method, a flow rate calculation program, and a fluid control device.

### Description of the Related Art

Denotation of symbols included in formulas below is as follows:
x: Coordinates of channel position in flow direction
y, r: Coordinate of channel positions in wall surface direction
x₁, x₂: Positions of inlet and outlet of channel
rₚᵢₚₑ: Radius of circular tube
h: Channel height of plane flow
w: Channel width of plane flow
l: Characteristic length
L: Channel length
A: Cross-sectional area of channel
Aₛ: Total cross-sectional area of channel
n: Number of channels
u: Flow rate
u_{α}: Apparent flow velocity in Forchheimer equation
p: Pressure
ρ₁, ρ₂: Channel inlet pressure and outlet pressure
ρ_{1,i}, ρ_{2,i}: Inlet pressure and outlet pressure of i-th data among N pieces of data
ρ_{std}: Pressure in standard state
Δρ: Difference between channel inlet pressure and channel outlet pressure, i.e. Δρ=ρ₁−ρ₂
T: Temperature
T_{std}: Temperature in standard state
ρ: Density
ρ_{std}: Density in standard state
q: Mass flow rate
q_{c}: Mass flow rate of continuous flow
qᵣ: Mass flow rate with rarefaction corrected
Q_{std}: Volumetric flow rate in standard state (standard volumetric flow rate)
Q_{std,i}: Volumetric flow rate (standard volumetric flow rate) of i-th data among N pieces of data, in standard state
μ: Viscosity coefficient
R: Specific gas constant
z: Compression factor
z_{std}: Compression factor in standard state
φ: Unit conversion coefficient from SI unit system of volumetric flow rate in standard state
α_{ρ}: Coefficient pertinent to cross-sectional shape, in mass flow rate of Poiseuille flow
α_{F}, b_{F}: Coefficients in Forchheimer equation
α_{Fi}: α_{F} of i-th channel, among n channels
cᵣ: Coefficient related to cross-sectional shape, in rarefaction correction
α: Tangential momentum accommodation coefficient
σ: Coefficient related to wall surface molecular reflection law, in rarefaction correction
λ: Mean free path
Kn: Knudsen number
K, K₁, K₂, K₃: Coefficients of basic formula
K₁ᵢ: K₁ of i-th channel, among n channels
χ: Intermediate variable
N: Number of pieces of data
∈ᵢ: Residual between i-th data in N pieces of data and regression curve

Pressure flow rate sensors calculate a flow rate of a fluid flowing through a channel by using an upstream pressure with respect to a fluid resistance element provided inside the channel, and a downstream pressure with respect to the fluid resistance element.

Specifically, a mass flow rate of a fluid passing through a fluid resistance element or a volumetric flow rate in a standard state is calculated using a basic formula obtained on the basis of a velocity distribution obtained from the theory of Poiseuille flow, such as the Hagen-Poiseuille equation or the two-dimensional Poiseuille flow equation,

$$Tube flow : u ( r ) = - \frac{{r}_{pipe}^{2}}{4 μ} \frac{dp ( x )}{dx} ( 1 - \frac{{r}^{2}}{{r}_{pipe}^{2}} ) \qquad ( 1 )$$

$$Plane flow : u ( y ) = - \frac{h}{2 μ} \frac{dp ( x )}{dx} y ( 1 - \frac{y}{h} ) \qquad ( 2 )$$

while permitting a change in the density with the equation of state of the gas, corrected with a compression factor z:

$$p = z ρ RT \qquad ( 3 )$$

When the flow can be approximated as a simple tube flow or plane flow, the mass flow rate and the standard volumetric flow rate are theoretically obtained as, by applying the equation of state of the gas to the velocity distribution and calculating the integral:

$$q = \frac{nA}{2 {a}_{P} L μ zRT} ( {p}_{1}^{2} - {p}_{2}^{2} ) \qquad ( 4 )$$

$${Q}_{std} = \frac{q φ}{{ρ}_{std}} = \frac{nA φ {z}_{std} {T}_{std}}{2 {a}_{P} L μ {zTp}_{std}} ( {p}_{1}^{2} - {p}_{2}^{2} ) \qquad ( 5 )$$

$${a}_{P} = \{ \begin{matrix}\frac{8}{{r}_{pipe}^{2}} & ( Tube flow ) \\ \frac{12}{{h}^{2}} & ( Plane flow )\end{matrix} \qquad ( 6 )$$

and the flow rates are used as the basis of the basic formula. The coefficient aₚ changes depending on the shape of the channel. Although representative examples of a tube flow and a plane flow are given in Formula (6), it is also possible for the channel to have a more complicated shape. In such a case, too, aₚ corresponding to such a shape can be determined theoretically or empirically.

Given a certain gas species and assuming a constant temperature and a small change in the compression factor z, Formula (5) is expressed as:

$${Q}_{std} = K ( {p}_{1}^{2} - {p}_{2}^{2} ) \qquad ( 7 )$$

using a single constant coefficient K, and this formula is used as the basic formula for a pressure flow meter. The coefficient K is determined empirically on the basis of data fitting. In practice, corrections for nonlinearity in the differential pressure/flow rate characteristics, the temperature, the pressure, and the gas type are added to the flow rates obtained from the basic formula. Furthermore, because each unit of flow meters exhibits an individual difference, mainly due to the dimensional errors, the resultant flow rates are also corrected in consideration of such a difference.

Because a volumetric flow rate in the standard state (hereinafter, standard volumetric flow rate) and a mass flow rate are values that are similar to each other and one can be converted into the other using a constant coefficient unique to the gas type, as in Formula (5), only formalization of the basic formula for the standard volumetric flow rate is mentioned above. In the description hereunder, formalization for the mass flow rate will be omitted in the same manner. However, in the derivation process, only the formalization for the mass flow rate the physical meaning of which is a clearer may be described.

### PRIOR ART DOCUMENT

### Patent Document

JP 2004-77327 A

### SUMMARY OF THE INVENTION

As can be seen in pressure mass flow controllers, there are limitations in the measurement range of a flow meter, due to factors such as the nonlinearity in the differential pressure/flow rate characteristics and the inertial resistance, in the high flow rate range, and due to the significant rarefaction gas effect in a low flow rate and low pressure condition. Such physical effects are not included in the basic formula that is based on the theory of Poiseuille flow; even if corrections are made using a polynomial or the like, the presence of significant errors in the basic formula result in a deterioration of accuracy in the final results. Therefore, there has been a problem in making accurate measurements using a single fluid resistance element structure, across a wide measurement range of the flow rate, from a low range to a high range.

The present invention has been made to address the problem described above, and an object of the present invention is to enable accurate flow rate calculations across a wide range of flow rate, from a low range to a high range.

That is, a pressure flow rate sensor according to the present invention includes: a fluid resistance element provided to a channel; an upstream pressure sensor that detects an upstream pressure with respect to the fluid resistance element; a downstream pressure sensor that detects a downstream pressure with respect to the fluid resistance element; and a flow rate calculation unit that calculates a flow rate based on the upstream pressure and the downstream pressure, in which the flow rate calculation unit calculates the flow rate based on viscous resistance, inertial resistance, and a degree of effect of rarefaction. Note the rarefaction herein is a phenomenon in which, as the pressure of the gas becomes extremely low or the system becomes extremely small, the size of the mean free path of a molecule with respect to a representative dimension of the system becomes nonnegligible. When this occurs, local equilibrium in molecular motion of the gas breaks down, and the rarefaction effect of the gas appears.

With such a pressure flow rate sensor, because the flow rate is calculated based on viscous resistance, inertial resistance, and a degree of effect of rarefaction, a flow rate can be calculated accurately across a wide range of flow rate, from a low range to a high range.

Specifically, because a flow rate is calculated based on a loss in the pressure in the flow laminarized in the fluid resistance element (viscous resistance), a loss in the pressure due to the inertia at the inlet and the outlet of the fluid resistance element, at the time of branching and merging, and the like (inertial resistance), and a degree of effect of rarefaction of the flow, a flow rate can be calculated accurately across a wide range of flow rate, from a low range to a high range.

The effect of the inertial resistance becomes significant in the high range of flow rate, but less significant in the low range of flow rate. In addition, the degree of effect of rarefaction increases in the low range of flow rate where the primary pressure is near the secondary pressure, but decreases in the high range of flow rate where the primary pressure is high. By incorporating inertial resistance and a degree of effect of rarefaction into the basic formula, a flow rate can be calculated accurately across a wide range of flow rate, from a low range to a high range.

As a specific embodiment of the flow rate calculation unit, the flow rate calculation unit preferably calculates a flow rate based on the following relational formula:

$${p}_{1}^{2} - {p}_{2}^{2} = {K}_{1} \times Q + {K}_{2} \times {Q}^{2} + {K}_{3} \times ( {p}_{1} - {p}_{2} ) \qquad Relational formula$$

Here, ρᵢ is the upstream pressure, ρ₂ is the downstream pressure, Q is the flow rate, and K₁ to K₃ are coefficients.

K₁×Q is a term representing viscous resistance, K₂×Q² is a term representing inertial resistance, and K₃×(ρ₁−ρ₂) is a term representing a degree of effect of rarefaction (hereinafter, a rarefaction-correcting term).

The above relational formula is a basic formula for a pressure flow meter, obtained by applying a rarefaction correction, which is inferred from a theoretical formula of a rarefied gas, to Forchheimer equation, and this relational formula corrects the errors introduced in a high flow rate range and a low flow rate range of the conventional basic formula indicated as Formula (7).

Before describing the relational formula mentioned above, the basic formula including the effect of inertia will be discussed. When there is an enlarged or contracted part, or a branched or merged part, including a fluid resistance element, between the upstream pressure sensor and the downstream pressure sensor, the flow comes to have inertia-dependent characteristics, and nonlinearity appears in the differential pressure/flow rate characteristics. As a flow model including the effects of viscous resistance and the inertial resistance that appear in Poiseuille flows, there is Forchheimer equation (Formula (8)), and the effect of inertia can be included by obtaining the basic formula from Forchheimer equation. The first term on the right side of Formula (8) represents viscous resistance, and the second term represents inertial resistance, and are characterized by shape-related model coefficients a_{F} and b_{F}, respectively.

Because Forchheimer equation models a fine and complicated channel system, such as a porous body, as a one-dimensional system having a space only in the flow direction, an apparent flow velocity uₐ is converted into a flow rate by introducing the total channel cross-sectional area Aₛ at a certain position. In other words, because the relationship of Formula (9) is established between an apparent flow velocity uₐ and a mass flow rate q, Forchheimer equation can be expressed as Formula (10). By considering the system as being homogeneous in the flow direction, while permitting a change in the density with the equation of state of the gas, Formula (11) is obtained by calculating the integral in the flow direction. Formula (12) is the result of conversion into the standard volumetric flow rate.

$$- \frac{dp}{dx} = {a}_{F} μ {u}_{a} + {b}_{F} ρ {u}_{a}^{2} \qquad ( 8 )$$

$$q = {A}_{s} ρ {u}_{a} \qquad ( 9 )$$

$$- \frac{dp}{dx} = \frac{{a}_{F} μ}{{A}_{s} ρ} q + \frac{{b}_{F}}{{A}_{s}^{2} ρ} {q}^{2} \qquad ( 10 )$$

$${p}_{1}^{2} - {p}_{2}^{2} = \frac{2 {a}_{F} L μ zRT}{{A}_{s}} q + \frac{2 {b}_{F} LzRT}{{A}_{s}^{2}} {q}^{2} \qquad ( 11 )$$

$${p}_{1}^{2} - {p}_{2}^{2} = \frac{2 {a}_{F} L μ {zTp}_{std}}{φ {A}_{s} {z}_{std} {T}_{std}} {Q}_{std} + \frac{2 {b}_{F} {LzTp}_{std}^{2}}{{φ}^{2} {A}_{s}^{2} {Rz}_{std}^{2} {T}_{std}^{2}} {Q}_{std}^{2} \qquad ( 12 )$$

Given a certain gas species and assuming a constant temperature and a small change in the compression factor z, Formula (12) can be simplified as Formula (13).

$${p}_{1}^{2} - {p}_{2}^{2} = {K}_{1} {Q}_{std} + {K}_{2} {Q}_{std}^{2} \qquad ( 13 )$$

This is a basic formula taking the effect of inertia into consideration.

Because Formula (13) is a quadratic equation of flow rate, a function of pressure for flow rate can be obtained as a formula for solving this equation. Using such a function, the flow rate can be calculated from the pressure. Alternatively, the flow rate can be obtained using a numerical operation such as an iterative operation.

The coefficients K₁ and K₂ are empirically obtained by fitting Formula (13) to data representing a relationship between the flow rate and the pressure of a fluid flowing through the channel. Because Formula (13) is a quadratic polynomial of flow rate, and therefore, the linear least squares method can be used, this fitting can be performed easily.

Assuming that the flow can be approximated as a tube flow or a plane flow, it is possible to, by giving K₁ as a theoretical coefficient,

$${K}_{1} = \frac{2 {a}_{F} L μ {zTp}_{std}}{φ {A}_{s} {z}_{std} {T}_{std}} \qquad ( 14 )$$

$${a}_{F} \approx {a}_{P} \qquad ( 15 )$$

obtain only K₂ by fitting.

Formula (12) may also be used as a basic formula. In such a case, the coefficients a_{F} and b_{F} in Forchheimer equation will be the coefficients of the basic formula. Each of the coefficients is a coefficient that changes depending on the shape of the channel, and can be obtained theoretically or empirically. When the flow can be approximated as a tube flow or a plane flow, aₚ can be theoretically given as Formula (6).

Even when the channel has any other cross-sectional shape, as long as the channel is isotropic, it is possible to theoretically obtain the coefficient a_{F} by approximating the flow as a tube flow using a hydraulic diameter or a hydraulic radius.

When there are a plurality of channels and such channels are positioned in a parallel or serial relationship, K₁ or α_{F} of the entire channel system can be given as follows, using theoretically obtained K₁ᵢ or a_{Fi} of each channel.

$$Parallel : {K}_{1} = \frac{1}{Σ1 / {K}_{1 i}} \qquad ( 16 )$$

$$Parallel : {a}_{F} = \frac{1}{Σ1 / {a}_{Fi}} \qquad ( 17 )$$

$$Series : {K}_{1} = \sum {K}_{1 i} \qquad ( 18 )$$

$$Series : {a}_{F} = \sum {a}_{Fi} \qquad ( 19 )$$

A basic formula including the effect of rarefaction, in addition to the effect of inertia represented as the relational formula, will now be described. Actual measurement data from a mass flow controller using the basic formula based on Forchheimer equation (Formula (13)) suffers a large fitting error in the low pressure and low flow rate range, due to the effect of rarefaction. Therefore, in order to achieve highly accurate measurements across a wide range, it is necessary to take the effect of rarefaction into consideration. The fitting error herein is a relative error in the flow rate predicted with a regression curve obtained by data fitting, with respect to the flow rate data, and will be used hereunder for the same meaning.

In the field of rarefied gases, velocity distributions of a tube flow and a plane flow including the rarefaction effect in the slip flow range with a low Reynolds number and a low Mach number have already been obtained as follows, by applying the Maxwell velocity slip, which is a velocity boundary condition expressing a rarefaction effect, to the theory of hydrodynamics. That is,

$$Tube flow : u ( x , r ) = - \frac{{r}_{pipe}^{2}}{4 μ} \frac{dp ( x )}{dx} ( 1 - \frac{1}{{r}_{pipe}^{2}} {r}^{2} + 2 σ \frac{λ}{{r}_{pipe}} ) \qquad ( 20 )$$

$$Plane flow : u ( x , y ) = - \frac{{h}^{2}}{8 μ} \frac{dp ( x )}{dx} ( 1 - \frac{4}{{h}^{2}} {y}^{2} + 4 σ \frac{λ}{h} ) \qquad ( 21 )$$

$$σ = \frac{2 - α}{α} \qquad ( 22 )$$

Here α is a tangential momentum accommodation coefficient, and represents a degree of diffuse reflection of a molecular reflection on a wall surface. Typically, 1 is given, assuming perfect diffuse reflection. λ denotes a mean free path. By multiplying the density to both sides of the velocity distribution, while permitting a change in density with the equation of state of the gas, and integrating the results by the cross section, Formula (23) is obtained. Here cᵣ is a coefficient that changes depending on the shape of the channel, l is a characteristic length, and Kn is a Knudsen number.

$$- \frac{dp}{dx} = \frac{2 {c}_{r} μ RT}{{l}^{2} Ap ( 1 + {c}_{r} σ Kn )} q \qquad ( 23 )$$

$${c}_{r} = \{ \begin{matrix}4 & ( Tube flow ) \\ 6 & ( Plane flow )\end{matrix} \qquad ( 24 )$$

$$l = \{ \begin{matrix}{r}_{pipe} & ( Tube flow ) \\ h & ( Plane flow )\end{matrix} \qquad ( 25 )$$

$$Kn = \frac{λ}{l} \qquad ( 26 )$$

Meanwhile, in the example that is based on the Poiseuille flow equation, by integrating the velocity distributions (Formula (1) and Formula (2)) by the cross section in the same manner, the formula can be expressed as:

$$- \frac{dp}{dx} = \frac{2 {c}_{r} μ RT}{{l}^{2} Ap} q \qquad ( 27 )$$

Comparing this formula with Formula (23), because the relationship

$${q}_{c} = \frac{1}{1 + {c}_{r} σ Kn} {q}_{r} \qquad ( 28 )$$

is established between the mass ow rate in the range of continuous ow an t e mass flow rate including the effect of rarefaction, this relationship is interpreted as a rarefaction correction in the mass flow rate.

Note that, with a tube flow and a plane flow, cᵣ is expressed as Formula (24), but can be theoretically or empirically determined even for a channel with any other shape.

Under the law of conservation of mass in flow, by integrating Formula (27) in the flow direction, and multiplying the number of a plurality of channels n, when there are a plurality of channels, the mass flow rate is obtained as:

$$q = \frac{{nl}^{2} A}{4 {c}_{r} μ zRT} ( {{p}_{1}}^{2} - {{p}_{2}}^{2} ) \qquad ( 29 )$$

Comparing this mass flow rate with Formula (4) indicated above, the following is established:

$${c}_{r} = \frac{{l}^{2}}{2} {a}_{P} \qquad ( 30 )$$

Therefore, one of the coefficient cᵣ and the coefficient aₚ can be estimated from the other.

Inferring a rarefaction-corrected form of Forchheimer equation expressed using the mass flow rate (Formula (10)), from Formula (28),

$$- \frac{dp}{dx} = \frac{{a}_{F} μ}{{A}_{s} ρ ( 1 + {c}_{r} σ Kn )} q + \frac{{b}_{F}}{{{A}_{s}}^{2} {ρ ( 1 + {c}_{r} σ Kn )}^{2}} {q}^{2} \qquad ( 31 )$$

is obtained. By applying the equation of state of the gas to this formula, and calculating the integral in the flow direction,

$${{p}_{1}}^{2} - {{p}_{2}}^{2} = \frac{2 {a}_{F} L μ zRT}{{A}_{s}} q + \frac{2 {b}_{F} LzRT}{{{A}_{s}}^{2}} ( 1 - \frac{χ}{{p}_{1} - {p}_{2}} ln \frac{{p}_{1} + χ}{{p}_{2} + χ} ) {q}^{2} - 2 χ ( {p}_{1} - {p}_{2} ) \qquad ( 32 )$$

$${{p}_{1}}^{2} - {{p}_{2}}^{2} = \frac{2 {a}_{F} L μ {zTp}_{std}}{φ {A}_{s} {z}_{std} {T}_{std}} {Q}_{std} + \frac{2 {b}_{F} {{LzTp}_{std}}^{2}}{{φ}^{2} {{A}_{s}}^{2} {{Rz}_{std}}^{2} {{T}_{std}}^{2}} ( 1 - \frac{χ}{{p}_{1} - {p}_{2}} ln \frac{{p}_{1} + χ}{{p}_{2} + χ} ) {{Q}_{std}}^{2} - 2 χ ( {p}_{1} - {p}_{2} ) \qquad ( 33 )$$

$$χ = {c}_{r} σ \sqrt{\frac{π RT}{2}} \frac{μ}{l} \qquad ( 34 )$$

is obtained. Note that the mean free path λ is approximated as a linear distribution as:

$$λ = \sqrt{\frac{π RT}{2}} \frac{μ}{p ( x )} \qquad ( 35 )$$

$$p ( x ) = - \frac{{p}_{1} - {p}_{2}}{L} ( x - {x}_{1} ) + {p}_{1} \qquad ( 36 )$$

Furthermore, in a case where ρ₁ is sufficiently higher than ρ₂, taking the conditions of a specific gas type and a pressure range in the mass flow controller into consideration, the flow rate is approximated as Formula (37). By converting this approximation to a standard volumetric flow rate, Formula (38) is obtained.

$${{p}_{1}}^{2} - {{p}_{2}}^{2} = \frac{2 {a}_{F} L μ zRT}{{A}_{s}} q + \frac{2 {b}_{F} LzRT}{{{A}_{s}}^{2}} {q}^{2} - 2 χ ( {p}_{1} - {p}_{2} ) \qquad ( 37 )$$

$${{p}_{1}}^{2} - {{p}_{2}}^{2} = \frac{2 {a}_{F} L μ {zTp}_{std}}{φ {A}_{s} {z}_{std} {T}_{std}} {Q}_{std} + \frac{2 {b}_{F} {{LzTp}_{std}}^{2}}{{φ}^{2} {{A}_{s}}^{2} {{Rz}_{std}}^{2} {{T}_{std}}^{2}} {{Q}_{std}}^{2} - 2 χ ( {p}_{1} - {p}_{2} ) \qquad ( 38 )$$

Given a certain gas species and assuming a constant temperature and a small change in the compression factor z, the above approximation is expressed as:

$${{p}_{1}}^{2} - {{p}_{2}}^{2} = {K}_{1} {Q}_{std} + {K}_{2} {{Q}_{std}}^{2} + {K}_{3} ( {p}_{1} - {p}_{2} ) \qquad ( 39 )$$

using the three constant coefficients K₁ to K₃. This is the basic formula including the effects of inertia and rarefaction, as indicated above as the relational formula.

Because Formula (39) is a quadratic equation of flow rate, a function of pressure for the flow rate can be obtained as a formula for solving this equation. The flow rate can thus be calculated from the pressure, using the function. Alternatively, the flow rate can be obtained using a numerical operation such as an iterative operation.

The coefficients K₁ and K₃ are empirically obtained by fitting Formula (39) to data indicating the relationship between the flow rate and the pressure of the fluid flowing through the channel. Because Formula (39) is a quadratic polynomial of flow rate, and therefore, the linear least squares method can be used, this fitting can be performed easily.

K₁ can also be given by Formula (14) and Formula (15) using the shape coefficient aₚ of the Poiseuille flow, in the same manner as that for the basic formula (Formula (13)) based on Forchheimer equation. aₚ is a coefficient that changes depending on the channel shape, and when the flow can be approximated as a tube flow or a plane flow, aₚ is given by Formula (6) but can be theoretically or empirically calculated for any other channel shape.

By comparing Formula (38) with Formula (39), K₃ can also be given by:

$${K}_{3} = - 2 χ = - 2 {c}_{r} σσ \sqrt{\frac{π RT}{2}} \frac{μ}{l} \qquad ( 40 )$$

cᵣ is a coefficient that changes depending on the channel shape, and when the flow can be approximated as a tube flow or a plane flow, cᵣ is given by Formula (24), but can be theoretically or empirically calculated for any other channel shape.

It is also possible to use Formula (38) as the basic formula. At that time, the coefficients a_{F} and b_{F} in Forchheimer equation and the coefficient cᵣ in the rarefaction correction serve as the coefficients of the basic formula. Each of the coefficients is a coefficient that changes depending on the shape of the channel, and can be obtained theoretically or empirically. aₚ can be theoretically given by Formula (6) when the flow can be approximated as a tube flow or a plane flow, and cᵣ can be theoretically given by Formula (24) when the flow can be approximated as a tube flow or a plane flow.

Even when the channel has any other cross-sectional shape, as long as the channel is isotropic, it is possible to theoretically obtain the coefficient aₚ by approximating the flow as a tube flow using a hydraulic diameter or a hydraulic radius.

When there are a plurality of channels and they are positioned in a parallel or serial relationship, K₁ or a_{F} of the entire channel system can be given as indicated by Formulas (16) to (19) using theoretically obtained K₁ᵢ or a_{Fi} of each of such channels.

Although the flow rate is approximated under the condition in which ρ₁ is sufficiently higher than ρ₂, actually, the mass flow controller uses a range outside this range. However, Formula (39) is useful because fitting errors with respect to a calibration data set are reduced, compared with a conventional counterpart that is based on the Poiseuille flow theory.

Formula (33) before applying the approximation may also be used as the basic formula. However, when the coefficient cᵣ is obtained from fitting, at least b_{F} also needs to be determined from fitting. Therefore, obtaining the coefficient cᵣ becomes a multivariable nonlinear optimization problem, and it becomes difficult to solve the problem stably, accurately, and quickly. When cᵣ is theoretically given, it is possible to obtain a_{F} and b_{F} using the linear least squares method. Past trials have indicated that, in such a case, there is not much difference from the case according to approximated Formula (39).

When the present invention is to be applied to a flow meter, corrections for nonlinearity in the flow rate/pressure characteristics, temperature, pressure, gas type, and individual unit difference may be added to the flow rate obtained from the relational formula, by using a high-order polynomial or the like, in the same manner as has been conventionally practiced.

Because the relational formula mentioned above is obtained by theoretically correcting the effect of inertia and rarefaction, as long as the overall degree of freedom in the final flow rate calculation formula, with other corrections included, is equivalent to that of the conventional basic formula, it can be expected that an additional improvement is achieved in the overall measurement accuracy, compared with that achieved with conventional basic formula. Otherwise, it can be expected that there will be a less freedom in making the corrections necessary to achieve the accuracy equivalent to that of the related art.

As a specific implementation of the fitting, it is possible to use fitting obtained from a weighted least squares method that uses the inverse of the flow rate as a weight.

When the coefficients K₁ to K₃ are obtained by fitting, because, with the ordinary least squares method, fitting errors increase in the low to middle range of flow rate. Therefore, the coefficients K₁ to K₃ are preferably obtained using the least squares method weighted by the inverse of the flow rate, as in the following formula. This weighting corresponds to emphasizing the low flow rate range.

$${ϵ}_{i} ( {K}_{1} , {K}_{2} , {K}_{3} ) = {{p}_{1 , i}}^{2} - {{p}_{2 , i}}^{2} - {K}_{1} {Q}_{std , i} - {K}_{2} {{Q}_{std , i}}^{2} - {K}_{3} ( {p}_{1 , i} - {p}_{2 , i} ) , \\ i = 1 , ... , N$$

$$arg min \{ \sum {( {ϵ}_{i} / {Q}_{std , i} )}^{2} \vert {K}_{1} , {K}_{2} , {K}_{3} ∈ ℝ \}$$

Because the rarefaction-correcting term, which is effective in the low flow rate range, has a degree of freedom, by emphasizing the low flow rate with the weighting described above, the degree of conformance is improved. As a result, the flow rate can be calculated accurately, particularly in the low flow rate range. Furthermore, because the channel size is used as the Kn number in the theoretical coefficient, the presence of dimensional errors may lead to an increase in fitting errors, depending on the application target. Therefore, by using an empirical coefficient as the coefficient K₃, fitting errors associated with the dimensional errors can be reduced.

The data may be obtained from actual measurement or by simulation. Generally actual measurement data is used in fitting for the purpose of calibrating measuring instruments. There may be some advantages in running separate simulation only for the purpose of obtaining some fitting coefficients only, from the viewpoint of difficulty or the like in collecting the actual measurements.

In addition, the flow rate calculation device according to the present invention is characterized by calculating a flow rate based on an upstream pressure with respect to a fluid resistance element provided in the channel, a downstream pressure with respect to the fluid resistance element, viscous resistance, inertial resistance, and a degree of effect of rarefaction.

Furthermore, a flow rate calculation method according to the present invention is characterized by being a flow rate calculation method using an upstream pressure sensor that detects an upstream pressure with respect to a fluid resistance element provided to a channel, and a downstream pressure sensor that detects a downstream pressure with respect to the fluid resistance element, in which the flow rate is calculated based on the upstream pressure, the downstream pressure, viscous resistance, inertial resistance, and a degree of effect of rarefaction.

Furthermore, a flow rate calculation program according to the present invention is characterized by being a flow rate calculation program used in a pressure flow rate sensor that measures a flow rate based on an upstream pressure with respect to a fluid resistance element provided to a channel and a downstream pressure with respect to the fluid resistance element, the flow rate calculation program providing a computer with a function of calculating a flow rate based on the upstream pressure, the downstream pressure, viscous resistance, inertial resistance, and a degree of effect of rarefaction.

The flow rate calculation program may be electronically distributed or may be recorded in a program recording medium such as a CD, a DVD, or a flash memory.

In addition, the fluid control device according to the present invention is characterized by including the pressure flow rate sensor described above and a fluid control valve provided upstream or downstream of the pressure flow rate sensor.

As described above, according to the present invention, a flow rate can be calculated accurately across a wide range of flow rate, from a low range to a high range.

### BRIEF DESCRIPTION OF THE DRAWINGS

FIG. 1 is a diagram schematically illustrating a configuration of a fluid control device according to one embodiment of the present invention;

FIG. 2 is a graph presenting experimental data, a basic formula based on a Poiseuille flow formula having coefficients determined by fitting to experimental data, a basic formula based on Forchheimer equation, and a basic formula based on a power law;

FIG. 3(a) is a graph illustrating fitting errors resulting from the basic formula based on Forchheimer equation;

FIG. 3(b) is a graph illustrating fitting errors resultant of a relational formula according to the present embodiment;

FIG. 4(a) is a graph indicating fitting errors with nitrogen (N₂);

FIG. 4(b) is a graph indicating fitting errors with sulfur hexafluoride (SF₆); and

FIG. 4(c) is a graph indicating fitting errors with helium (He).

### DETAILED DESCRIPTION

### One Embodiment of Present Invention

One embodiment of a fluid control device incorporated with a pressure flow rate sensor according to the present invention will now be described with reference to drawings. Note that all of the drawings described below are schematic representations with some omissions and exaggerations made as appropriate, in order to facilitate understanding. The same elements are denoted by the same reference numerals, and the descriptions thereof will be omitted as appropriate.

### <Device Configuration>

The fluid control device 100 according to the present embodiment is used in a semiconductor manufacturing process, for example, and is provided to one or more gas supply lines to control the flow rate of the process gas flowing through each of the gas supply lines.

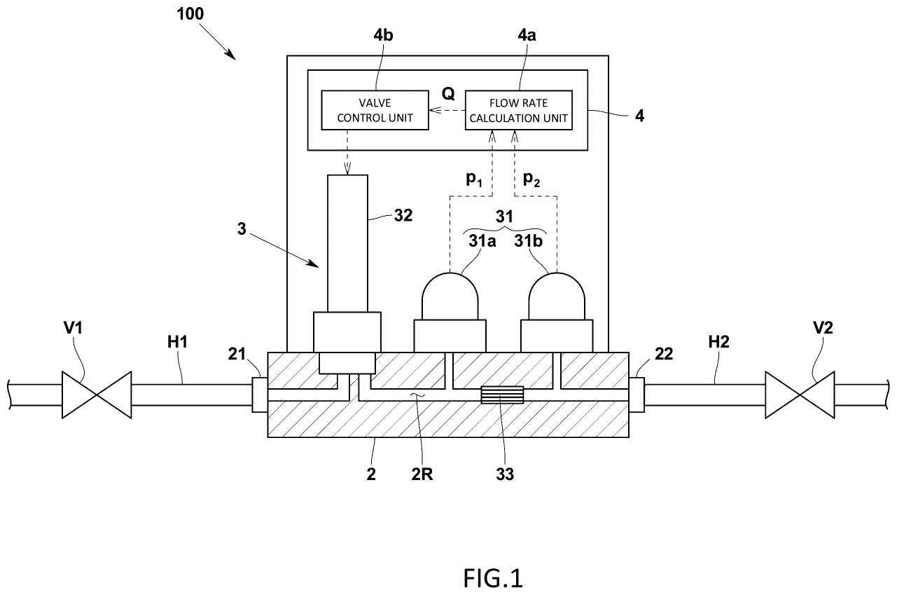

Specifically, the fluid control device 100 is what is called a differential pressure mass flow controller (differential pressure MFC), and includes a channel block 2 having a plurality of internal channels 2R, and a fluid controller 3 mounted on the channel block 2, as illustrated in FIG. 1.

The channel block 2 has an inlet port 21 for guiding a fluid into the internal channels 2R and an outlet port 22 for guiding the fluid outside of the internal channels 2R. An upstream pipe H1 is connected to the inlet port 21, and an upstream pneumatic valve V1 is provided to the upstream pipe H1. The outlet port 22 is connected to a downstream pipe H2, and a downstream pneumatic valve V2 is provided to the downstream pipe H2.

The fluid controller 3 controls the fluid through the internal channels 2R, and includes the flow rate sensor 31 for measuring the flow rate of the fluid flowing through the internal channels 2R, and the fluid control valve 32 provided upstream of the flow rate sensor 31. The degree by which the fluid control valve 32 is opened is feedback-controlled by a control unit 4, to be described later.

The flow rate sensor 31 is a pressure flow rate sensor, and includes an upstream pressure sensor 31a provided upstream of a fluid resistance element 33 such as a restrictor or an orifice provided inside the internal channels 2R, and a downstream pressure sensor 31b provided downstream of the fluid resistance element 33. A flow rate calculation unit 4a included in the control unit 4, to be described later, then calculates a flow rate Q flowing through the internal channels 2R, based on an upstream pressure ρ₁ of the fluid resistance element 33, detected by the upstream pressure sensor 31a and a downstream pressure ρ₂ of the fluid resistance element 33, detected by the downstream pressure sensor 31b.

The fluid control valve 32 is provided upstream of the pressure flow rate sensor 31. Specifically, the fluid control valve 32 controls the flow rate by advancing and retracting a valve plug with respect to a valve seat, using a piezoelectric actuator. The fluid control valve 32 is controlled by a valve control unit 4b included in the control unit 4.

The control unit 4 includes a flow rate calculation unit 4a that calculates the flow rate Q flowing through the internal channels 2R, based on the upstream pressure ρ₁ and the downstream pressure ρ₂, and a valve control unit 4b that controls the fluid control valve 32 based on the flow rate Q calculated by the flow rate calculation unit 4a. Note that the control unit 4 is what is called a computer including a CPU, a memory, A/D and D/A converters, and an input/output unit, for example, and functions as the flow rate calculation unit 4a, the valve control unit 4b, and the like, by executing a fluid control program stored in the memory and cooperating with various devices.

The flow rate calculation unit 4a according to the present embodiment calculates the flow rate Q based on viscous resistance, inertial resistance, and a degree of effect of rarefaction.

Specifically, the flow rate calculation unit 4a calculates the flow rate Q based on the following relational formula F:

$${{p}_{1}}^{2} - {{p}_{2}}^{2} = {K}_{1} \times Q + {K}_{2} \times {Q}^{2} + {K}_{3} \times ( {p}_{1} - {p}_{2} ) . \qquad Relational formula F$$

Here ρ₁ is the upstream pressure, ρ₂ is the downstream pressure, Q is the flow rate, and K₁ to K₃ are coefficients.

K₁×Q is a term representing viscous resistance, K₂×Q² is a term representing inertial resistance, and K₃×(ρ₁−ρ₂) is a term representing a degree of effect of rarefaction.

K₁ to K₃ are empirical coefficients obtained by fitting the relational formula F to data representing a relationship between measured flow rate of flows flowing through the channels 2R, and the pressure. For the fitting, a linear least squares method may be used. K₁ to K₃ may be obtained by fitting the relational formula F to the relationship between simulated flow rates of flows flowing through the channels 2R, and the pressure.

When the coefficients K₁ to K₃ are obtained by fitting, because, with the ordinary least squares method, fitting errors increase in the low to middle range of the flow rate. Therefore, the coefficients K₁ to K₃ are preferably obtained using a weighted least squares method using the inverse of the flow rate as a weight, as in the following Formula. This weighting corresponds to emphasizing the low flow rate range.

$${ϵ}_{i} ( {K}_{1} , {K}_{2} , {K}_{3} ) = {{p}_{1 , i}}^{2} - {{p}_{2 , i}}^{2} - {K}_{1} {Q}_{std , i} - {K}_{2} {{Q}_{std , i}}^{2} + {K}_{3} ( {p}_{1 , i} - {p}_{2 , i} ) , \\ i = 1 , ... , N$$

$$arg min \{ \sum {( {ϵ}_{i} / {Q}_{std , i} )}^{2} \vert {K}_{1} , {K}_{2} , {K}_{3} ∈ ℝ \}$$

Because the rarefaction-correcting term, which is effective in the low flow rate range, has a degree of freedom, by emphasizing the low flow rate with the weighting described above, the degree of conformance is improved. As a result, the flow rate can be calculated accurately, particularly in the low flow rate range. Furthermore, because the channel size is used as the Kn number in the theoretical coefficient, the presence of dimensional errors may lead to an increase in fitting errors, depending on the application target. Therefore, by using an empirical coefficient as the coefficient K₃, fitting errors associated with the dimensional errors can be reduced.

### <Experiment Data and Results of Fitting Each Formula>

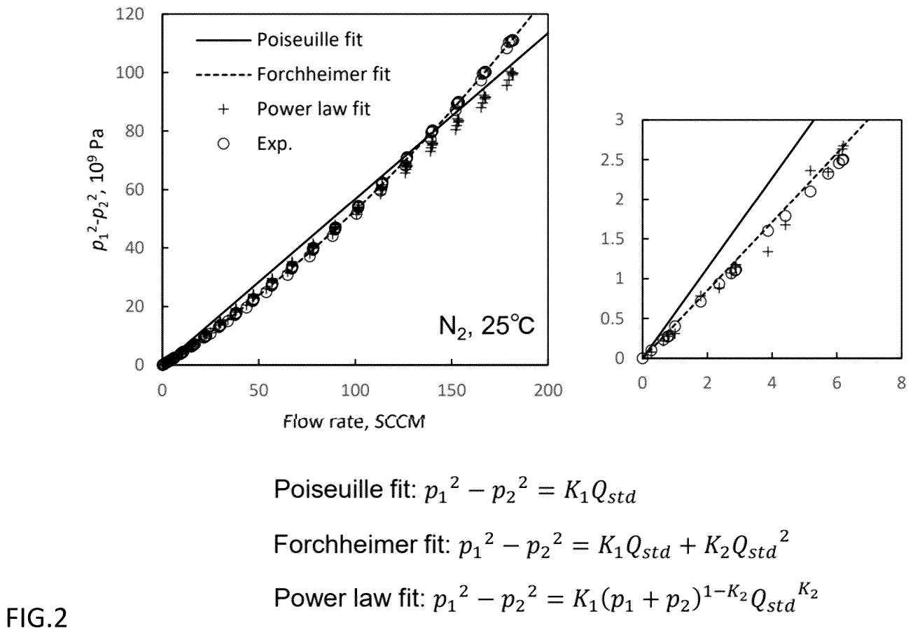

FIG. 2 is a graph presenting experimental data, a basic formula based on a Poiseuille flow formula having coefficients determined by fitting to experimental data, a basic formula based on Forchheimer equation, and a basic formula based on a power law. The gas species used in this experiment is nitrogen gas. Each formula is represented by the following, and coefficients K₁ and K₂ in each of the formulas are different from those in the others.

$${{p}_{1}}^{2} - {{p}_{2}}^{2} = {K}_{1} {Q}_{std} \qquad Poiseuille fit$$

$${{p}_{1}}^{2} - {{p}_{2}}^{2} = {K}_{1} {Q}_{std} + {K}_{2} {{Q}_{std}}^{2} \qquad Forchheimer fit$$

$${{p}_{1}}^{2} - {{p}_{2}}^{2} = {K}_{1} {{Q}_{std}}^{{K}_{2}} \qquad Power law fit$$

In the basic formula based on a Poiseuille flow, fitting results exhibit significant errors on the low side of flow rates, as well as on the high side. The basic formula based on Forchheimer equation fits the best, as compared with the other formulas, and is particularly excellent in a high flow rate range. The basic formula also exhibits errors in a low flow rate range, at a level equivalent to those of the basic formula that is based on the power law.

### <Results of Fitting Present Relational Formula to Experimental Data>

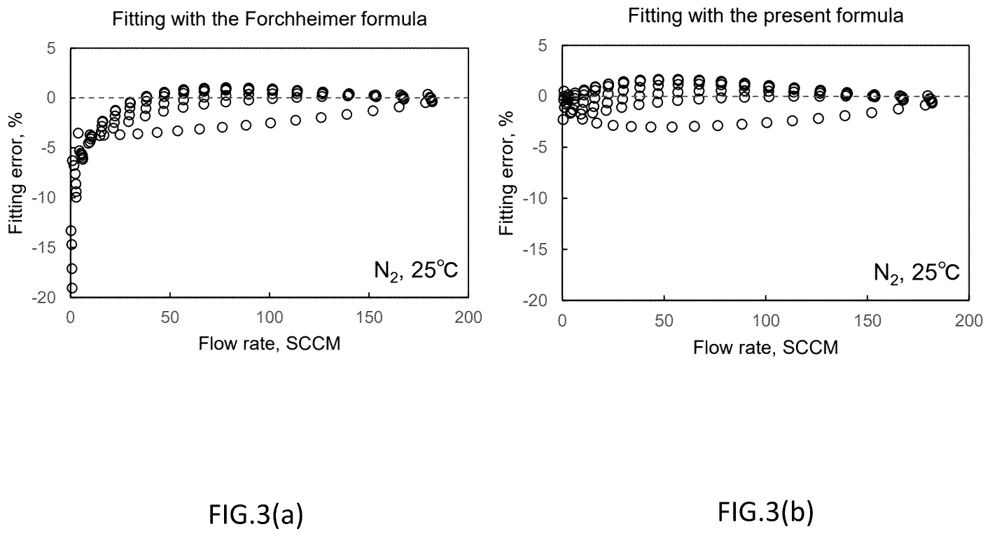

FIG. 3(a) is a graph illustrating fitting errors resulting from the basic formula based on Forchheimer equation, and FIG. 3(b) is a graph illustrating fitting errors resulting from the present formula. The gas species used in this experiment is nitrogen gas. Each formula is represented by the following, and coefficients K₁ and K₂ in each of the formulas are different from those in the others.

$${{p}_{1}}^{2} - {{p}_{2}}^{2} = {K}_{1} {Q}_{std} + {K}_{2} {{Q}_{std}}^{2} \qquad ( a )$$

$${{p}_{1}}^{2} - {{p}_{2}}^{2} = {K}_{1} {Q}_{std} + {K}_{2} {{Q}_{std}}^{2} + {K}_{2} ( {p}_{1} - {p}_{2} ) \qquad ( b )$$

Comparing FIGS. 3(a) and 3(b), it can be seen that the negative errors of Forchheimer equation in the low flow rate range are improved by introducing the rarefaction-correcting term into Forchheimer equation. In addition, even in a high flow rate range where the effect of inertia is significant, the accuracy of fitting achieved by introducing the rarefaction-correcting term is not greatly impaired.

### Advantageous Effects Achieved by Embodiment

As described above, with the fluid control device 100 according to the present embodiment, because the flow rate is calculated based on viscous resistance, inertial resistance, and a degree of effect of rarefaction, a flow rate can be calculated accurately across a wide range of flow rate, from a low range to a high range. As a result, the flow rate can be controlled accurately across a wide range of flow rate, from a low range to a high range.

Specifically, because the flow rate is calculated based on a loss in the pressure in the flow laminarized in the fluid resistance element (viscous resistance; K₁×Q), a loss in the pressure due to the inertia at the inlet and outlet of the fluid resistance element, at the time of branching and merging, and the like (inertial resistance; K₂×Q²), and a degree of effect of rarefaction of the flow (degree of effect of rarefaction; K₃×(ρ₁−ρ₂)), a flow rate can be calculated accurately across a wide range of flow rate, from a low range to a high range.

The effect of the inertial resistance becomes significant in the high range of flow rate, but less significant in the low range of flow rate. In addition, the degree of effect of rarefaction increases in the low range of flow rate where the primary pressure is near the secondary pressure, but decreases in the high range of flow rate where the primary pressure is high. By incorporating inertial resistance and a degree of effect of rarefaction into the basic formula, a flow rate can be calculated accurately across a wide range of flow rate, from a low range to a high range.

Furthermore, in the present embodiment, because the fluid resistance element 33 is provided downstream of the fluid control valve 32, the fluid resistance element 33 is in a low pressure environment in the low flow rate range, and the flow rate increases due to the rarefaction of the flow. Even in such a case, in the present embodiment, because the flow rate is calculated based on the effect of the rarefaction of the flow (the degree of effect of rarefaction; K₃×(ρ₁−ρ₂)), the flow rate can be calculated accurately.

### Another Embodiment 1

In the embodiment described above, K₁ may also be a theoretical coefficient represented by Formula (14). Specifically, the formula is as follows (quoted again). Here aₚ is a coefficient depending on the shape of the channel, and is expressed as Formula (6) when the system can be approximated as a tube flow or a plane flow. In addition, Aₛ is the total cross-sectional area of the channel, and when the channel can be approximated to a collective channel in which circular tubes or sufficiently flat rectangular tubes are connected in parallel, the cross-sectional area A of one channel is multiplied by the number of channels n.

In this embodiment, by replacing empirical coefficients with theoretical coefficients, the degree of freedom in data fitting can be reduced. Although theoretical coefficients are affected by dimensional errors resultant of machining errors, when the number of data points is small or the errors of data with respect to the true values are significant, an increase in the errors due to overfitting of the formula with respect to true values can be prevented, as long as the dimensional errors are at a level at which the fitting accuracy is maintained. That is, it is possible to expect an improvement in the validity of the formula.

$${K}_{1} = \frac{2 {a}_{F} L μ {zTp}_{std}}{φ {A}_{s} {z}_{std} {T}_{std}} \qquad ( 14 )$$

$${a}_{F} \approx {a}_{P} \qquad ( 15 )$$

$${a}_{P} = \{ \begin{matrix}\frac{8}{{{r}_{pipe}}^{2}} & ( Tube flow ) \\ \frac{12}{{h}^{2}} & ( Plane flow )\end{matrix} \qquad ( 6 )$$

At this time, the flow rate calculation unit 4a calculates the flow rate Q based on the following formulas determined by the empirical coefficients K₂ and K₃.

$${{p}_{1}}^{2} - {{p}_{2}}^{2} = \frac{16 L μ {zTp}_{std}}{φ {{r}_{pipe}}^{2} {A}_{s} {z}_{std} {T}_{std}} {Q}_{std} + {K}_{2} {{Q}_{std}}^{2} + {K}_{3} ( {p}_{1} - {p}_{2} ) \qquad ( Tube flow )$$

$${{p}_{1}}^{2} - {{p}_{2}}^{2} = \frac{24 L μ {zTp}_{std}}{φ {h}^{2} {A}_{s} {z}_{std} {T}_{std}} {Q}_{std} + {K}_{2} {{Q}_{std}}^{2} + {K}_{3} ( {p}_{1} - {p}_{2} ) \qquad ( Plane flow )$$

### Another Embodiment 2

K₃ in the embodiment described above may be a theoretical coefficient represented by Formula (40). Specifically, the formula is as follows (quoted again). Here cᵣ is a coefficient that is dependent on the shape of the channel, and l is a characteristic length. When the system can be approximated as a tube flow or a plane flow, cᵣ takes a value indicated in Formula (24). At this time, the length represented by Formula (25) is used as 1; that is, the radius of the circular tube, rₚᵢₚₑ in the case of a tube flow, and the channel height h, in the case of a plane flow, are used.

In this embodiment, in the same manner as in Another Embodiment 1, by replacing an empirical coefficient with a theoretical coefficient, the degree of freedom in the data fitting can be reduced. Although theoretical coefficients are affected by dimensional errors resultant of machining errors, when the number of data points is small or the errors of data with respect to the true values are significant, an increase in the errors due to overfitting of the formula with respect to true values can be prevented, as long as the dimensional errors are at a level at which the fitting accuracy is maintained. That is, it is possible to expect an improvement in the validity of the formula. Because the term in which an empirical coefficient is replaced with a theoretical coefficient is different from that in Another Embodiment 1, it is expected that the degree of effect would be different from that in the Another Embodiment 1, depending on the fluid resistance element, the range of physical conditions to be used, and the characteristics of data, and therefore, there is room for selection.

$${K}_{3} = - 2 χ = - 2 {c}_{r} σ \sqrt{\frac{π RT}{2}} \frac{μ}{l} \qquad ( 40 )$$

$$σ = \frac{2 - α}{α} \qquad ( 22 )$$

$${c}_{r} = \{ \begin{matrix}4 & ( Tube flow ) \\ 6 & ( Plane flow )\end{matrix} \qquad ( 24 )$$

$$l = \{ \begin{matrix}{r}_{pipe} & ( Tube flow ) \\ h & ( Plane flow )\end{matrix} \qquad ( 25 )$$

At this time, the flow rate calculation unit 4a calculates the flow rate Q based on of the following formula determined by the empirical coefficients K₁ and K₂.

$${{p}_{1}}^{2} - {{p}_{2}}^{2} = {K}_{1} {Q}_{std} + {K}_{2} {{Q}_{std}}^{2} - 4 \frac{2 - α}{α} \frac{μ \sqrt{2 π RT}}{{r}_{pipe}} ( {p}_{1} - {p}_{2} ) \qquad ( Tube flow )$$

$${{p}_{1}}^{2} - {{p}_{2}}^{2} = {K}_{1} {Q}_{std} + {K}_{2} {{Q}_{std}}^{2} - 6 \frac{2 - α}{α} \frac{μ \sqrt{2 π RT}}{h} ( {p}_{1} - {p}_{2} ) \qquad ( Plane flow )$$

### Another Embodiment 3

K₁ and K₃ in the embodiment described above may both be theoretical coefficients represented by Formulas (14) and (40), respectively, in the same manner as in Another Embodiment 1 and Another Embodiment 2.

In this embodiment, because a larger number of empirical coefficients are replaced with theoretical coefficients than those in Embodiment 1 and Embodiment 2, it is possible to further reduce the degree of freedom of data fitting. Therefore, although theoretical coefficients are affected more by dimensional errors resultant of machining errors, when the number of data points is small or the errors of data with respect to the true values are significant, an increase in the error due to overfitting of the formula with respect to true values can be prevented, as long as the dimensional errors are at a level at which the fitting accuracy is maintained. That is, it is possible to expect a further improvement in the validity of the formula.

$${{p}_{1}}^{2} - {{p}_{2}}^{2} = \frac{16 L μ {zTp}_{std}}{φ {{r}_{pipe}}^{2} {A}_{s} {z}_{std} {T}_{std}} {Q}_{std} + {K}_{2} {{Q}_{std}}^{2} - 4 \frac{2 - α}{α} \frac{μ \sqrt{2 π RT}}{{r}_{pipe}} ( {p}_{1} - {p}_{2} ) \qquad ( Tube flow )$$

$${{p}_{1}}^{2} - {{p}_{2}}^{2} = \frac{24 L μ {zTp}_{std}}{φ {h}^{2} {A}_{s} {z}_{std} {T}_{std}} {Q}_{std} + {K}_{2} {{Q}_{std}}^{2} - 6 \frac{2 - α}{α} \frac{μ \sqrt{2 π RT}}{h} ( {p}_{1} - {p}_{2} ) \qquad ( Plane flow )$$

### <Fitting Error Resultant of Using Theoretical Coefficient as Coefficient K₃>

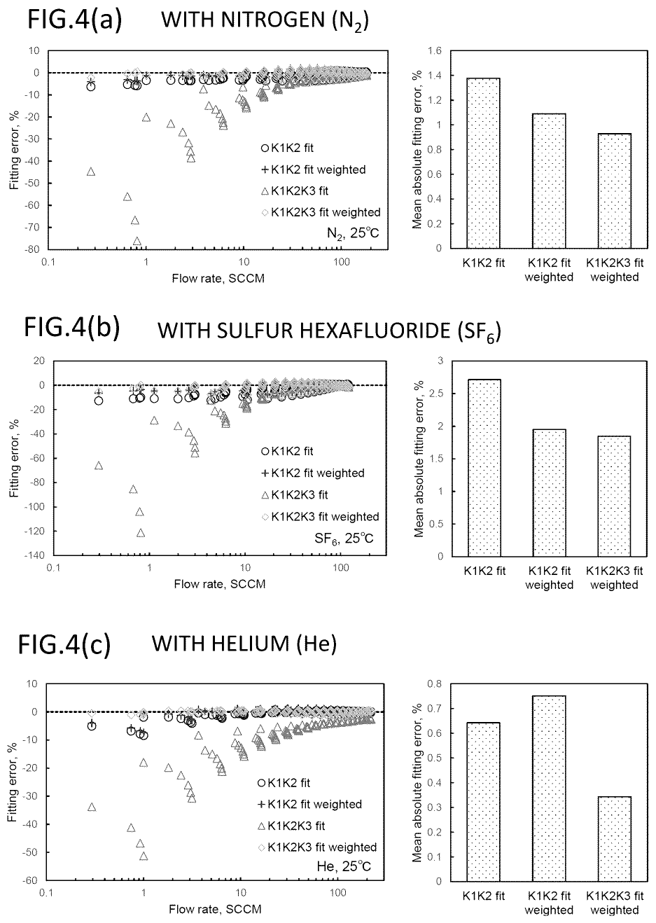

FIGS. 4(a), 4(b), and 4(c) illustrate fitting errors resultant of using a theoretical coefficient as the coefficient K₃. In FIGS. 4(a), 4(b), and 4(c), “K1K2” indicates an example in which empirical coefficients are used as the coefficients K₁ and K₂, and a theoretical coefficient is used as the coefficient K₃. “K1K2K3” indicates an example in which empirical coefficients are used for all of the coefficients K₁ to K₃, that is, indicates the relational formula of the above embodiment. “fit” indicates an example in which fitting is carried out using a normal linear least squares method, and “fit weighted” indicates an example in which the fitting is carried out using a weighted linear least squares method that emphasizes a low flow rate range.

Looking at the example of nitrogen (N₂) illustrated in FIG. 4(a), “K1K2K3 fit weighted” has a degree of freedom in conforming to the low flow rate range, so that the fitting errors are the smallest, with the weighting for emphasizing the low flow rate range. Although fitting errors in “K1K2 fit” are small, the fitting errors are greater than those in “K1K2K3 fit weighted”, because the K₃ is theoretically predicted and thus there is no degree of freedom in conforming, in the low flow rate range. With the weighting for emphasizing the low flow rate range, “K1K2 fit weighted” is better than “K1K2 fit”, but because there is no degree of freedom in conforming, in the low flow rate range, the fitting errors are greater than those in “K1K2K3 fit weighted”. Furthermore, “K1K2K3 fit” has a degree of freedom in conforming in the low flow rate range, but is not used in the ordinary linear least squares method.

Also with sulfur hexafluoride (SF₆) and helium (He) indicated in FIGS. 4(b) and 4(c), respectively, “K1K2K3 fit weighted” has the smallest fitting errors, and “K1K2 fit” is inferior to “K1K2K3 fit weighted” but works, in the same manner as for nitrogen (N₂).

Furthermore, a database may be built in advance, for a part or all of the terms or the coefficients included in the relational formula K₁×Q+K₂×Q²+K₃×(ρ₁−ρ₂) according to the embodiment. In such a case, such a term or coefficient may be obtained by calculating an approximation of data by applying an interpolation to a simple reference or database, and use the terms or coefficients in the flow rate calculation. Possible variables of the database include a flow rate, a pressure, a temperature, a gas type, or a combination thereof. Furthermore, when the database includes a flow rate as a variable, the flow rate can be obtained by calculating a flow rate by assigning a tentative value, e.g., 0 to a target term or coefficient in the flow rate calculation, by then obtaining a corresponding value of the target term or coefficient from the database based on the calculated flow rate, and by performing a numerical operation such as an iterative operation, e.g., calculating the flow rate again, using the corresponding value. At the point in time at which a change in the flow rate obtained by the iterative operation becomes smaller than an acceptable value, or at the point in time at which a predetermined number of iterative operations are completed, for example, the flow rate may be used as the final flow rate.

In the embodiment described above, the pressure flow rate sensor 31 is incorporated in the fluid control device, but the pressure flow rate sensor 31 may be used by itself.

In the embodiment described above, the flow rate is expressed by a standard volumetric flow rate (SCCM), but may also be converted into a mass flow rate.

In the formulas according to the present invention, ρ₁>ρ₂ is assumed. However, the roles of ρ₁ and ρ₂ may be switched when ρ₁<ρ₂ that is, when the flow is a backflow.

The pressure flow rate sensor 31 may also be configured to measure the difference between the inlet pressure and the outlet pressure of the channel using a differential pressure sensor (differential pressure Δρ), for example, and to calculate the flow rate from the differential pressure Δp and the upstream pressure ρ₁ or the differential pressure Δp and the downstream pressure ρ₂, without limitation to the combination of the upstream pressure ρ₁ and the downstream pressure ρ₂.

The data used in fitting may be based on a simulation or a theoretical formula, without limitation to the data based on actual measurement.

Any other various modifications and combinations of the embodiments are still possible within the scope not deviating from the gist of the present invention.

### REFERENCE CHARACTERS LIST

100 fluid control device
Q flow rate
ρ₁ upstream pressure
ρ₂ downstream pressure
2R channel
31 pressure flow rate sensor
31a upstream pressure sensor
31b downstream pressure sensor
32 fluid control valve
33 fluid resistance element
4a flow rate calculation unit

What is claimed is:

1. A pressure flow rate sensor comprising:
a fluid resistance element provided to a channel;
an upstream pressure sensor that detects an upstream pressure with respect to the fluid resistance element;
a downstream pressure sensor that detects a downstream pressure with respect to the fluid resistance element; and
a flow rate calculation unit that calculates a flow rate based on the upstream pressure and the downstream pressure,
wherein the flow rate calculation unit calculates the flow rate based on viscous resistance, inertial resistance, and a degree of effect of rarefaction.

2. The pressure flow rate sensor according to claim 1, wherein the flow rate calculation unit calculates the flow rate based on a following relational formula:
$${{p}_{1}}^{2} - {{p}_{2}}^{2} = {K}_{1} \times Q + {K}_{2} \times {Q}^{2} + {K}_{3} \times ( {p}_{1} - {p}_{2} ) , \qquad Relational Formula$$
where
ρ₁ is the upstream pressure, ρ₂ is the downstream pressure, Q is the flow rate, and K₁ to K₃ are coefficients,
K₁×Q is a term indicating the viscous resistance,
K₂×Q² is a term indicating the inertial resistance, and
K₃×(ρ₁−ρ₂) is a term indicating the degree of effect of rarefaction.

3. The pressure flow rate sensor according to claim 2, wherein the coefficients K₁ to K₃ are obtained from a weighted least squares method in which an inverse of a flow rate is used as a weight in fitting the relational formula with respect to a relationship between a measured value or a simulated value of the flow rate of a fluid flowing through the channel and a pressure.

4. The pressure flow rate sensor according to claim 2, wherein
a flow in the fluid resistance element is approximable as a tube flow or a plane flow, and the coefficient K₁ is obtained from a length L of the fluid resistance element, a radius rₚᵢₚₑ of the tube flow or a channel height h of the plane flow, an area A of the channel, a total cross-sectional area Aₛ of the channel, number n of channels, a temperature T, a specific gas constant R, a viscosity coefficient μ, a compression factor z, a unit conversion coefficient φ of a volumetric flow rate in a standard state from an SI unit system, a pressure ρ_{std} in the standard state, a temperature T_{std} in the standard state, and a compression factor z_{std} in the standard state, as
$${K}_{1} = \frac{2 {a}_{P} L μ {zTp}_{std}}{φ {A}_{s} {z}_{std} {T}_{std}}$$
when the flow rate Q is a volumetric flow rate Q_{std} in the standard state,
$${K}_{1} = \frac{2 {a}_{P} L μ zRT}{{A}_{s}}$$
when the flow rate Q is a mass flow rate q, and
where
$${a}_{P} = \{ \begin{matrix}\frac{8}{{{r}_{pipe}}^{2}} & ( Tube flow ) \\ \frac{12}{{h}^{2}} & ( Plane flow )\end{matrix}$$
$${A}_{s} = nA$$
is given, and the coefficient K₂ and the coefficient K₃ are obtained by a weighted least squares method using an inverse of a flow rate as a weight in fitting the relational formula with respect to a relationship between a measured value or a simulated value of the flow rate of a fluid flowing through the channel and the pressure.

5. The pressure flow rate sensor according to claim 2, wherein
a flow in the fluid resistance element is approximable as a tube flow or a plane flow, and the coefficient K₃ is obtained from a radius rₚᵢₚₑ of the tube flow or a channel height h of the plane flow, a temperature T, a specific gas constant R, a viscosity coefficient, and a tangential momentum adaptive coefficient α, as
$${K}_{3} = - 2 {c}_{r} σ \sqrt{\frac{π RT}{2}} \frac{μ}{l}$$
where
$$σ = \frac{2 - α}{α}$$
$${c}_{r} = \{ \begin{matrix}4 & ( Tube flow ) \\ 6 & ( Plane flow )\end{matrix}$$
$$l = \{ \begin{matrix}{r}_{pipe} & ( Tube flow ) \\ h & ( Plane flow )\end{matrix}$$
is given, and the coefficients K₁ and K₂ are obtained by a weighted least squares method using an inverse of a flow rate as a weight in fitting the relational formula with respect to a relationship between a measured value or a simulated value of the flow rate of a fluid flowing through the channel and the pressure.

6. The pressure flow rate sensor according to claim 2, wherein the flow in the fluid resistance element is approximable as a tube flow or a plane flow, the coefficient K₁ is obtained from a length L of the fluid resistance element, a radius rₚᵢₚₑ of the tube flow or a channel height h of the plane flow, an area A of the channel, a total cross-sectional area Aₛ of the channel, number n of channels, a temperature T, a specific gas constant R, a viscosity coefficient μ, a compression factor z, a unit conversion coefficient φ of a volumetric flow rate in a standard state from an SI unit system, a pressure ρ_{std} in the standard state, a temperature T_{std} in the standard state, and a compression factor z_{std} in the standard state, as
$${K}_{1} = \frac{2 {a}_{P} L μ {zTp}_{std}}{φ {A}_{s} {z}_{std} {T}_{std}}$$
when the flow rate Q is a volumetric flow rate Q_{std} in the standard state,
$${K}_{1} = \frac{2 {a}_{P} L μ zRT}{{A}_{s}}$$
when the flow rate Q is a mass flow rate q, and
where
$${a}_{P} = \{ \begin{matrix}\frac{8}{{{r}_{pipe}}^{2}} & ( Tube flow ) \\ \frac{12}{{h}^{2}} & ( Plane flow )\end{matrix}$$
$${A}_{s} = nA$$
is given,
the coefficient K₂ is obtained by a weighted least squares method using an inverse of a flow rate as a weight in fitting the relational formula with respect to a relationship between a measured value or a simulated value of the flow rate of a fluid flowing through the channel and the pressure, and
the coefficient K₃ is obtained from a radius rₚᵢₚₑ of the tube flow or a channel height h of the plane flow, a temperature T, a specific gas constant R, a viscosity coefficient, and a tangential momentum adaptive coefficient α, as
$${K}_{3} = - 2 {c}_{r} σ \sqrt{\frac{π RT}{2}} \frac{μ}{l}$$
where
$$σ = \frac{2 - α}{α}$$
$${c}_{r} = \{ \begin{matrix}4 & ( Tube flow ) \\ 6 & ( Plane flow )\end{matrix}$$
$$l = \{ \begin{matrix}{r}_{pipe} & ( Tube flow ) \\ h & ( Plane flow )\end{matrix}$$
is given.

7. A flow rate calculation device configured to calculate a flow rate based on an upstream pressure with respect to a fluid resistance element provided to a channel, a downstream pressure with respect to the fluid resistance element, viscous resistance, inertial resistance, and a degree of effect of rarefaction.

8. A flow rate calculation method using an upstream pressure sensor that detects an upstream pressure with respect to a fluid resistance element provided to a channel, and a downstream pressure sensor that detects a downstream pressure with respect to the fluid resistance element, wherein the flow rate is calculated based on the upstream pressure, the downstream pressure, viscous resistance, inertial resistance, and a degree of effect of rarefaction.

9. A non-transitory computer readable medium storing instructions for a flow rate calculation program used with a pressure flow rate sensor that measures a flow rate based on an upstream pressure with respect to a fluid resistance element provided to a channel and a downstream pressure with respect to the fluid resistance element, wherein the instructions, when executed by a computer cause the computer to:
calculate a flow rate based on the upstream pressure, the downstream pressure, viscous resistance, inertial resistance, and a degree of effect of rarefaction.

10. A fluid control device comprising:
the pressure flow rate sensor according to claim 1; and
a fluid control valve provided upstream or downstream of the pressure flow rate sensor.
